(19) United States
(12) Patent Application Publication
(10) Pub. No.: US 2025/0106590 A1
(43) Pub. Date: Mar. 27, 2025

(54) METHOD AND APPARATUS FOR COMMUNICATION IN AN IAB NETWORK

(71) Applicant: Lenovo (Beijing) Limited, Beijing (CN)

(72) Inventors: Yibin Zhuo, Beijing (CN); Mingzeng Dai, Shanghai (CN); Lianhai Wu, Beijing (CN); Le Yan, Shanghai (CN)

(73) Assignee: Lenovo (Beijing) Limited, Beijing (CN)

(21) Appl. No.: 18/832,427

(22) PCT Filed: Jan. 25, 2022
(86) PCT No.: PCT/CN2022/073743

§ 371 Date: Jul. 23, 2024

(51) Int. Cl. H04W 4/02; H04W 12/08; H04W 36/00; H04W 36/32; H04W 88/04

(52) U.S. Cl. CPC H04W 4/025; H04W 12/08; H04W 36/0055; H04W 36/324; H04W 88/04

(57) ABSTRACT

Embodiments of the present disclosure relate to wireless communication in an integrated access and backhaul (IAB) network. According to some embodiments of the disclosure, a method performed by a UE may include: determining a location status of the UE relative to a mobile wireless network node based on a criterion. wherein the mobile wireless network node is allowed to serve as a mobile relay node between a BS and the UE: and transmitting the determined location status of the CE to at least one of the mobile wireless network node or the BS.

### TECHNICAL FIELD

Embodiments of the present disclosure generally relate to communication technology, and more particularly to communication in an integrated access and backhaul (IAB) network.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), the 3rd generation partnership project (3GPP) is envisioning integrated access and backhaul (IAB) architecture for supporting multi-hop relays. In an IAB network, an IAB node may hop through one or more IAB nodes before reaching a base station (also referred to as “an IAB donor” or “a donor node”). A single hop may be considered a special instance of multiple hops. Multi-hop backhauling is beneficial because it provides a relatively greater coverage extension compared to single-hop backhauling. In a relatively high frequency radio communication system (e.g., radio signals transmitted in frequency bands over 6 GHz), relatively narrow or less signal coverage may benefit from multi-hop backhauling techniques.

The industry desires technologies for handling wireless communications in the IAB network.

### SUMMARY

Some embodiments of the present disclosure provide a user equipment (UE). The UE may include a processor, wherein the processor may be configured to determine a location status of the UE relative to a mobile wireless network node based on a criterion, wherein the mobile wireless network node is allowed to serve as a mobile relay node between a base station (BS) and the UE. The UE may further include a transceiver coupled to the processor, wherein the transceiver may be configured to transmit the determined location status of the UE to at least one of the mobile wireless network node or the BS.

In some embodiments of the present disclosure, determining the location status of the UE based on a criterion may include determining the location status of the UE based on at least one of the following: a measurement result on a reference signal from the mobile wireless network node; a variation of the measurement result on the reference signal from the mobile wireless network node; at least one of a speed and moving direction of the UE and the mobile wireless network node; or an indication from an application layer of the UE. In some examples, to determine the location status of the UE based on the measurement result, the processor may be configured to determine whether the measurement result is greater than or equal to a threshold, or is greater than or equal to the threshold for a time period. In some examples, to determine the location status of the UE based on the variation of the measurement result, the processor may be configured to determine whether the variation of the measurement result within a time period is less than or equal to a threshold.

Some embodiments of the present disclosure provide a mobile wireless network node. The mobile wireless network node may include a processor, wherein the processor may be configured to determine to access a parent node based on a first indication broadcast by a cell of the parent node, wherein the mobile wireless network node is allowed to serve as a mobile relay node between the parent node and a user equipment (UE). The mobile wireless network node may further include a transceiver coupled to the processor, wherein the transceiver may be configured to transmit a second indication to the parent node, wherein the second indication indicates a mobile attribute of the mobile wireless network node.

In some embodiments of the present disclosure, the transceiver may be further configured to perform at least one of the following: broadcast an indication indicating the mobile attribute of the mobile wireless network node; or transmit a reference signal specific for determining a location status of a UE. In some examples, the reference signal may be transmitted only when a speed of the mobile wireless network node is greater than or equal to a threshold.

In some embodiments of the present disclosure, the processor may be further configured to perform at least one of the following: selecting a working mode from at least one working mode supported by the mobile wireless network node and applying the selected working mode; applying a working mode configured by the parent node; or generating a list of UEs allowed to access the mobile wireless network node.

Some embodiments of the present disclosure provide a base station (BS). The BS may include a processor; and a transceiver coupled to the processor. The transceiver may be configured to: broadcast a first indication indicating that a mobile wireless network node is supported, wherein the mobile wireless network node is allowed to serve as a mobile relay node between the BS and a user equipment (UE); and receive a second indication from the mobile wireless network node, wherein the second indication indicates a mobile attribute of the mobile wireless network node.

In some embodiments of the present disclosure, the transceiver may be further configured to receive at least one of the following from the mobile wireless network node: at least one working mode supported by the mobile wireless network node, wherein the at least one working mode comprises a public working mode and a private working mode; a current working mode of the mobile wireless network node; or a list of UEs allowed to access the mobile wireless network node.

In some embodiments of the present disclosure, the transceiver may be further configured to perform at least one of the following: transmit a working mode configuration to the mobile wireless network node; periodically receive a list of UEs allowed to access the mobile wireless network node; receive the list of UEs allowed to access the mobile wireless network node in response to a change in the list; or receive the change in the list of UEs.

In some embodiments of the present disclosure, the processor may be configured to perform an access control for the mobile wireless network node based on the list of UEs when the mobile wireless network node is in a private working mode.

In some embodiments of the present disclosure, the processor may be configured to configure a cell of the BS or a relay node whether the mobile wireless network node is barred from the cell.

Some embodiments of the present disclosure provide a method performed by a user equipment (UE). The method may include: determining a location status of the UE relative to a mobile wireless network node based on a criterion, wherein the mobile wireless network node is allowed to serve as a mobile relay node between a base station (BS) and the UE; and transmitting the determined location status of the UE to at least one of the mobile wireless network node or the BS.

Some embodiments of the present disclosure provide a method performed by a mobile wireless network node. The method may include: determining to access a parent node based on a first indication broadcast by a cell of the parent node, wherein the mobile wireless network node is allowed to serve as a mobile relay node between the parent node and a user equipment (UE); and transmitting a second indication to the parent node, wherein the second indication indicates a mobile attribute of the mobile wireless network node.

Some embodiments of the present disclosure provide a method performed by a base station (BS). The method may include: broadcasting a first indication indicating that a mobile wireless network node is supported, wherein the mobile wireless network node is allowed to serve as a mobile relay node between the BS and a user equipment (UE); and receiving a second indication from the mobile wireless network node, wherein the second indication indicates a mobile attribute of the mobile wireless network node.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an example block diagram of a protocol stack for an IAB network in accordance with some embodiments of the present disclosure;

FIG. 3 illustrates an example block diagram of a protocol stack for an IAB network in accordance with some embodiments of the present disclosure;

FIG. 4 illustrates a flow chart of an exemplary procedure of wireless communications in accordance with some embodiments of the present disclosure;

FIGS. 5A-5C illustrate a flow chart of an exemplary procedure of wireless communications in accordance with some embodiments of the present disclosure;

FIG. 6 illustrates a flow chart of an exemplary procedure of wireless communications in accordance with some embodiments of the present disclosure;

FIG. 7 illustrates a flow chart of an exemplary procedure of wireless communications in accordance with some embodiments of the present disclosure;

FIG. 8 illustrates a flow chart of an exemplary procedure of wireless communications in accordance with some embodiments of the present disclosure;

FIG. 9 illustrates a flow chart of an exemplary procedure of wireless communications in accordance with some embodiments of the present disclosure;

FIG. 10 illustrates a flow chart of an exemplary procedure of wireless communications in accordance with some embodiments of the present disclosure; and

FIG. 11 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

Compared with the 4G communication system, the 5G communication system has raised more stringent requirements for various network performance indicators, for example, a 1000-time capacity increase, wider coverage requirements, ultra-high reliability, ultra-low latency, etc. Considering the rich frequency resources of high-frequency carriers, the use of high-frequency small station deployments is becoming more and more popular in hotspot areas in order to meet the needs of 5G ultra-high capacity. However, high-frequency carriers have poor propagation characteristics, severe attenuation due to obstructions, and limited coverage. Therefore, the dense deployment of small stations is required. In addition, the deployment of optical fiber may be difficult and costly for these small stations. Therefore, an economical and convenient backhaul scheme is needed. Integrated access and backhaul (IAB) technology, whose access link(s) and backhaul link(s) may both use wireless transmission solutions to avoid fiber deployment, provides ideas for solving the above problems.

In an IAB network, a relay node (RN) or an IAB node or a wireless backhaul node/device can provide wireless access services for UEs. That is, a UE can connect to an IAB donor relayed by one or more IAB nodes. The IAB donor may also be called a donor node or a donor base station (e.g., DgNB, Donor gNodeB). In addition, the wireless link between an IAB donor and an IAB node, or the wireless link between different IAB nodes can be referred to as a “backhaul link.”

An IAB node may include an IAB mobile terminal (MT) part and an IAB distributed unit (DU) part. When an IAB node connects to its parent node (which may be another IAB node or an IAB donor), it can be regarded as a UE, i.e., the role of an MT. When an IAB node provides service to its child node (which may be another IAB node or a UE), it can be regarded as a network device, i.e., the role of a DU.

An IAB donor can be an access network element with a complete base station function, or an access network element with a separate form of a centralized unit (CU) and a distributed unit (DU). The IAB donor may be connected to the core network (for example, connected to the 5G core network (5GC)), and provide the wireless backhaul function for the IAB nodes. The CU of an IAB donor may be referred to as an “IAB donor-CU” (or directly referred to as a “CU”), and the DU of the IAB donor may be referred to as an “IAB donor-DU.” The IAB donor-CU may be separated into a control plane (CP) and a user plane (UP). For example, a CU may include one CU-CP and one or more CU-UPs.

Considering the small coverage of a high frequency band, and in order to ensure the coverage performance of the network, multi-hop networking may be adopted in an IAB network. Taking into account the requirements of service transmission reliability, IAB nodes can support dual connectivity (DC) or multi-connectivity to improve the reliability of transmission, so as to deal with abnormal situations that may occur on the backhaul (BH) link, such as radio link failure (RLF) or blockage, load fluctuations, etc.

In the case where an IAB network supports multi-hop and dual-connection networking, there may be multiple transmission paths between the UE and the IAB donor. A transmission path may include multiple nodes, such as a UE, one or more IAB nodes, and an IAB donor (if the IAB donor is in the form of a separate CU and DU, it may also contain an IAB donor-DU and an IAB donor-CU). Each IAB node may treat the neighboring node that provides backhaul services for it as a parent node (or parent IAB node), and each IAB node can be regarded as a child node (or child IAB node) of its parent node.

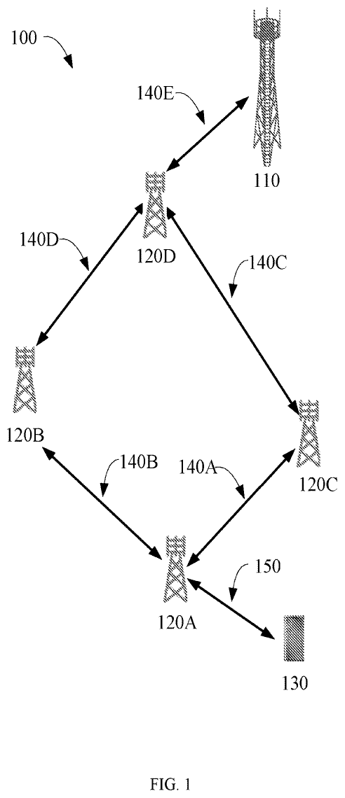

FIG. 1 illustrates a schematic diagram of a wireless communication system 100 in accordance with some embodiments of the present disclosure.

As shown in FIG. 1, the wireless communication system 100 may include a base station (e.g., IAB donor 110), some IAB nodes (e.g., IAB node 120A, IAB node 120B, IAB node 120C, and IAB node 120D), and a UE (e.g., UE 130). Although a specific number of UEs, IAB nodes, and IAB donors is depicted in FIG. 1, it is contemplated that any number of UEs, IAB nodes, and IAB donors may be included in the wireless communication system 100.

Each of IAB donor 110, IAB node 120A, IAB node 120B, IAB node 120C and IAB node 120D may be directly connected to one or more IAB nodes in accordance with some other embodiments of the present disclosure. Each of IAB donor 110. IAB node 120A, IAB node 120B, IAB node 120C and IAB node 120D may be directly connected to one or more UEs in accordance with some other embodiments of the present disclosure.

UE 130 may be any type of device configured to operate and/or communicate in a wireless environment. For example, UE 130 may include a computing device, such as a desktop computer, a laptop computer, a personal digital assistant (PDA), a tablet computer, a smart television (e.g., television connected to the Internet), a set-top box, a game console, a security system (including a security camera), a vehicle on-board computer, a network device (e.g., router, switch, and modem), or the like. According to some embodiments of the present disclosure, UE 130 may include a portable wireless communication device, a smart phone, a cellular telephone, a flip phone, a device having a subscriber identity module, a personal computer, a selective call receiver, or any other device that is capable of transmitting and receiving communication signals on a wireless network. In some embodiments of the present disclosure, UE 130 may include wearable devices, such as smart watches, fitness bands, optical head-mounted displays, internet-of-things (IoT) devices, or the like. Moreover, UE 130 may be referred to as a subscriber unit, a mobile, a mobile station, a user, a terminal, a mobile terminal, a wireless terminal, a fixed terminal, a subscriber station, a user terminal, or a device, or described using other terminology used in the art.

IAB donor 110 may be in communication with a core network (not shown in FIG. 1). The core network (CN) may include a plurality of core network components, such as a mobility management entity (MME) (not shown in FIG. 1) or an access and mobility management function (AMF) (not shown in FIG. 1). The CNs may serve as gateways for the UEs to access a public switched telephone network (PSTN) and/or other networks (not shown in FIG. 1).

Wireless communication system 100 may be compatible with any type of network that is capable of transmitting and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, IAB donor 110 may transmit data using an orthogonal frequency division multiple (OFDM) modulation scheme on the DL. UE 130 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

Persons skilled in the art should understand that as technology develops and advances, the terminologies described in the present disclosure may change, but should not affect or limit the principles and spirit of the present disclosure.

Referring to FIG. 1, IAB node 120D can be directly connected to IAB donor 110. IAB donor 110 is a parent node of IAB node 120D. In other words, IAB node 120D is a child IAB node of IAB donor 110. IAB nodes 120B and 120C can reach IAB donor 110 by hopping through IAB node 120D. IAB node 120D is a parent IAB node of IAB nodes 120B and 120C. In other words, IAB nodes 120B and 120C are child IAB nodes of IAB node 120D.

IAB node 120A can be connected to IAB node 120B so it can reach IAB donor 110 by hopping through IAB node 120B and IAB node 120D. IAB node 120A and IAB node 120B may be referred to as the downstream (or descendant) IAB nodes of IAB node 120D. IAB node 120B and IAB node 120D may be referred to as the upstream IAB nodes of IAB node 120A. IAB node 120A can also be connected to IAB node 120C so it can reach IAB donor 110 by hopping through IAB node 120C and IAB node 120D.

UE 130 can be connected to IAB node 120A. Uplink (UL) packets (c.g., data or signaling) from UE 130 can be transmitted to an IAB donor (e.g., IAB donor 110) via one or more IAB nodes, and then transmitted by the IAB donor to a mobile gateway device (such as the user plane function (UPF) in 5GC). Downlink (DL) packets (e.g., data or signaling) can be transmitted from the IAB donor (c.g., IAB donor 110) after being received by the gateway device, and then transmitted to UE 130 through one or more IAB nodes. For example, referring to FIG. 1, UE 130 may transmit UL data to IAB donor 110 or receive DL data therefrom via IAB node 120A.

In an IAB deployment such as the wireless communication system 100, the radio link between an IAB donor (c.g., IAB donor 110 in FIG. 1) and an IAB node or between two IAB nodes may be referred to as a backhaul link (BL). The radio link between an IAB donor (c.g., IAB donor 110 in FIG. 1) and a UE or between an IAB node and a UE may be referred to as an access link (AL). For example, in FIG. 1, radio links 140A to 140E are BLs and radio link 150 is an AL.

An egress BH link may refer to a BH link on which a packet is transmitted by a node (c.g., an IAB node or IAB donor). An ingress BH link may refer to a BH link on which a packet is received by a node (e.g., an IAB node or IAB donor). An egress BH RLC channel may refer to a BH RLC channel on which a packet is transmitted by a node (e.g., an IAB node or IAB donor). An ingress BH RLC channel may refer to a BH RLC channel on which a packet is received by a node (e.g., an IAB node or IAB donor). For example, from the perspective of IAB node 120B, an egress BH RLC channel may refer to a BH RLC channel between 120B and 120D or a BH RLC channel between IAB nodes 120B and 120A. For instance, for UL, an egress BH RLC channel of IAB node 120B may refer to a BH RLC channel between IAB nodes 120B and 120D; and for DL, an egress BH RLC channel of IAB node 120B may refer to a BH RLC channel between IAB nodes 120B and 120A.

A protocol layer, the backhaul adaptation protocol (BAP) layer, located above the radio link control (RLC) layer, is introduced in an IAB system and can be used to realize packet routing, bearer mapping and flow control on the wireless backhaul link.

An F1 interface may be established between an IAB node (e.g., the DU part of the IAB node) and an IAB donor (e.g., IAB donor-CU). The F1 interface may support both a user plane protocol (e.g., F1-U) and a control plane protocol (e.g., F1-C). The user plane protocol of the F1 interface may include one or more of a general packet radio service (GPRS) tunneling protocol user plane (GTP-U), user datagram protocol (UDP), internet protocol (IP) and other protocols. The control plane protocol of the F1 interface may include one or more of an F1 application protocol (F1AP), stream control transport protocol (SCTP), IP, and other protocols.

Through the control plane of the F1 interface, an IAB node and an IAB donor can perform, for example, interface management, IAB-DU management, and a UE context-related configuration. Through the user plane of the F1 interface, an IAB node and an IAB donor can perform, for example, user plane data transmission and downlink transmission status feedback functions.

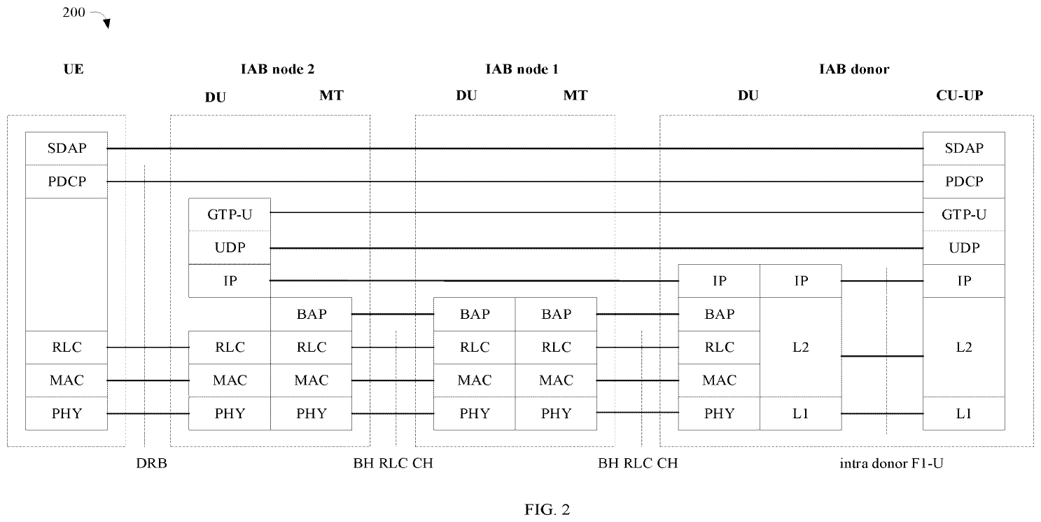

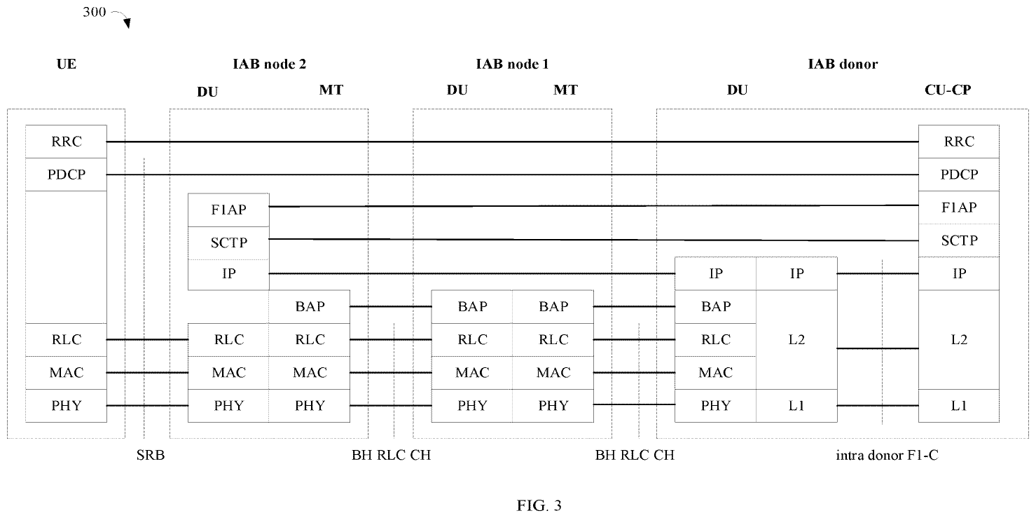

FIG. 2 illustrates an example block diagram of a user plane (UP) protocol stack 200 for an IAB network according to some embodiments of the present disclosure. FIG. 3 illustrates an example block diagram of a control plane (CP) protocol stack 300 for an IAB network according to some embodiments of the present disclosure. In FIGS. 2 and 3, a UE may be connected to an IAB donor via IAB node 2 and IAB node 1.

Referring to FIG. 2, the UP protocol stack of the UE may include a service data adaptation protocol (SDAP) layer, a packet data convergence protocol (PDCP) layer, a radio link control (RLC) layer, a medium access control (MAC) layer, and a physical (PHY) layer. The UP protocol stack of the DU of IAB node 2 may include a GTP-U layer, a UDP layer, an IP layer, an RLC layer, a MAC layer, and a PHY layer. The UP protocol stack of the MT of IAB node 2 or the DU or MT of IAB node 1 may include a BAP layer, an RLC layer, a MAC layer, and a PHY layer. The UP protocol stack of the DU of the IAB donor may include an IP layer, a BAP layer, an RLC layer, a MAC layer, and a PHY layer, where the PHY layer belongs to layer 1 (L1), and the BAP layer, the RLC layer, and the MAC layer belong to layer 2 (L2). The protocol stack of the CU-UP of the IAB donor may include a GTP-U layer, a UDP layer, an IP layer, an SDAP layer, a PDCP layer, an L2 layer(s), and an L1 layer.

Referring to FIG. 3, the CP protocol stack of the UE may include a radio resource control (RRC) layer, a PDCP layer, an RLC layer, a MAC layer, and a physical (PHY) layer. The CP protocol stack of the DU of IAB node 2 may include an F1AP layer, an SCTP layer, an IP layer, an RLC layer, a MAC layer, and a PHY layer. The CP protocol stack of the MT of IAB node 2 or the DU or MT of IAB node 1 may include a BAP layer, an RLC layer, a MAC layer, and a PHY layer. The CP protocol stack of the DU of the IAB donor may include an IP layer, a BAP layer, an RLC layer, a MAC layer, and a PHY layer, where the PHY layer belongs to L1, and the BAP layer, the RLC layer, and the MAC layer belong to L2. The protocol stack of the CU-CP of the IAB donor may include an RRC layer, a PDCP layer, an F1AP layer, an SCTP layer, an IP layer, an L2 layer(s), and an L1 layer.

The protocol stacks shown in FIGS. 2 and 3 are only for illustrative purposes. For example, the sequences of some of the protocol layers in the protocol stacks of FIGS. 2 and 3 may be rearranged for illustrative purposes. For example, although the SDAP and PDCP layers belong to L2, they are shown above the GTP-U layer, the UDP layer and the IP layer in the protocol stack of the CU-UP of the IAB donor in FIG. 2.

As demand for improved cellular coverage and connectivity continues to increase, communications in outdoor and mobility scenarios may face more challenges. In some embodiments of the present disclosure, a mobile wireless network node which acts as a relay between a UE and the 3GPP communication network (e.g., 5G) may be employed to facilitate communications in such scenarios. The mobile wireless network node may provide, for example, an access link to UEs and connected wirelessly (e.g., using NR) through a BS (e.g., donor next-generation radio access network (NG-RAN)) to the core network. In some examples, such mobile wireless network node may also be referred to as a mobile base station relay or mobile relay. The above descriptions with respect to the IAB node can be applied to the mobile base station relay. That is, a mobile base station relay can be a mobile IAB node.

In some examples, the mobile base station relay may be mounted on a vehicle. In these examples, the mobility characteristics (e.g., speed or moving direction) of the mobile base station relay may be the same as those of the vehicle. The mobile base station relay may serve UEs that are located inside or outside the vehicle, or UEs that enter or leave the vehicle.

In some examples, the radio link used between a mobile base station relay and the served UEs, as well as between the mobile base station relay and the BS, may be the Uu link (e.g., NR-Uu). Therefore, a mobile base station relay is different from a UE relay (which uses instead a PC5-based link to provide an indirect connection to remote UEs). In some examples, there may be at least one hop between a UE and a mobile base station relay. In some examples, there may be at least one hop between a mobile base station relay and a BS.

The employment of such mobile wireless network node is advantageous in various aspects and can be applied to various scenarios. For example, in some outdoor environments, the availability of vehicles equipped with mobile base station relays, either following a certain known/predictable itinerary (e.g., buses, trams, etc.), or situated in convenient locations (e.g., outside stadiums, hot-spot areas, or emergency sites), could provide a very opportunistic boost to cellular coverage and capacity when or where needed. Those relays may use, for example, a 5G wireless backhaul toward the macro network, and thus can offer better coverage and connectivity to neighboring UEs. Mobile relays are also very suitable for improving connectivity for users or devices inside a vehicle on which the mobile relay is mounted in different environments, for example, for passengers in buses, cars/taxis, or trains, ad-hoc/professional personnel or equipment. Such mobile wireless network node can also be used for reaching users or devices that would otherwise have no or very poor macro coverage, for example, in the case of first responders dislocated in indoor buildings/areas, using relays placed on their nearby or outside vehicles to get required coverage and connectivity.

The technical benefits of using such mobile wireless network node further include, among others, the ability to get better macro coverage than a nearby UE, for example, exploiting better radio frequency, antenna and power capabilities. In addition, besides the value for network operators and end users, worthy incentives could be found for other parties as well, for example, for vehicle manufacturers, vehicle and fleet owners or providers, to install and operate relays in their vehicles.

Embodiments of the present disclosure provide solutions for facilitating the employment and utilization of such mobile wireless network node. More details on the embodiments of the present disclosure will be illustrated in the following text in combination with the appended drawings.

In some embodiments of the present disclosure, it would be beneficial to differentiate the location statuses of a UE relative to a mobile wireless network node, for example, whether the UE is inside of the vehicle on which the mobile wireless network node is mounted (hereinafter, “an onboard UE”) or is outside the vehicle (hereinafter, “a surrounding UE”). For example, by providing such information to the mobile wireless network node or a BS, the UE may be handled in a more proper and efficient manner.

In the context of the present disclosure, inside or outside of a mobile wireless network node may mean inside or outside of a vehicle or other devices on which the mobile wireless network node is mounted. In addition, in the context of the present disclosure, detecting, accessing, receiving a signal from, or transmitting a signal to, or other similar operations associated with a mobile wireless network node may mean detecting, accessing, receiving a signal from, or transmitting a signal, or the other similar operations associated with a cell of the mobile wireless network node.

In some embodiments of the present disclosure, under at least one of the following conditions, the UE may determine a location status of the UE relative to a mobile wireless network node: periodic; in response to a request from a mobile wireless network node or a BS; when the UE detects a mobile wireless network node or detects a cell of the mobile wireless network node; or when the UE has accessed the mobile wireless network node. In some embodiments of the present disclosure, as will be described in more detail below, the UE may determine its location status based on a criterion. In some embodiments of the present disclosure, the UE may transmit the determined location status to the mobile wireless network node or the BS.

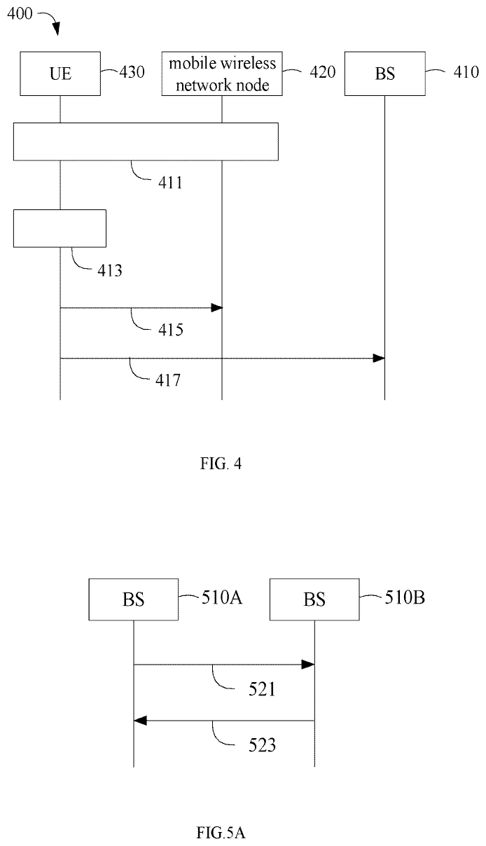

FIG. 4 illustrates a flow chart of an exemplary procedure 400 of wireless communications in accordance with some embodiments of the present disclosure. Details described in all of the foregoing embodiments of the present disclosure are applicable for the embodiments shown in FIG. 4.

Referring to FIG. 4, in operation 411, UE 430 may detect mobile wireless network node 420 or a cell of mobile wireless network node 420, or UE 430 may perform an access to the mobile wireless network node 420 or an access to a cell of mobile wireless network node 420. Mobile wireless network node 420 can serve as a mobile relay node between BS 410 (e.g., the serving BS of mobile wireless network node 420) and UE 430. In some embodiments, mobile wireless network node 420 may be a mobile IAB node.

In some examples, UE 430 can determine whether a detected cell is a cell of a mobile wireless network node based on an indication in the broadcast information. For example, as will be described in detail in the following text, the broadcast information may indicate a mobile attribute of the mobile wireless network node. In some examples, UE 430 can determine whether a detected cell is a cell of a mobile wireless network node based on a reference signal(s) specific for a cell of a mobile wireless network node.

In some embodiments of the present disclosure, UE 430 may start to determine its location status in response to detecting mobile wireless network node 420 or a cell of mobile wireless network node 420. In some embodiments of the present disclosure, UE 430 may determine its location status when UE 430 has accessed mobile wireless network node 420 or has accessed a cell of mobile wireless network node 420. In some embodiments of the present disclosure, UE 430 may determine its location status periodically. In some embodiments of the present disclosure, UE 430 may determine its location status in response to a request from mobile wireless network node 420 or BS 410.

In operation 413, UE 430 may determine its location status with respect to mobile wireless network node 420 (e.g., inside or outside the vehicle on which mobile wireless network node 420 is mounted) based on one or more criteria.

In some embodiments of the present disclosure, UE 430 may determine its location status based on a measurement result (e.g., reference signal received power (RSRP) or reference signal received quality (RSRQ)) on a reference signal from mobile wireless network node 420 or a cell of mobile wireless network node 420. In some examples, the reference signal may include, but not limited to, a synchronization signal, a DL demodulation reference signal (DMRS), a DL positioning reference signal (PRS) and a CSI reference signal.

In some examples, the reference signal can be a mobile wireless network node-specific reference signal. For example, such reference signal may only be transmitted by a cell of a mobile wireless network node. For instance, a BS or a stationary relay node may not be allowed to transmit such reference signal. In some examples, the reference signal can only be transmitted when the mobile wireless network node is moving (e.g., above a specific speed). For instance, when the vehicle on which mobile wireless network node 420 is mounted is moving, the mobile wireless network node can transmit such reference signal. Such reference may be designed for a mobile wireless network node to differentiate the onboard UEs or surrounding UEs.

In some examples, UE 430 may determine whether the measurement result satisfies a measurement result threshold (e.g., equal to or above an RSRP or RSPQ absolute threshold), and may determine that it is inside the vehicle of mobile wireless network node 420 when the threshold is satisfied. Otherwise, when the threshold is not satisfied (e.g., the measurement result is below the RSRP or RSPQ absolute threshold), UE 430 may determine that it is outside the vehicle of mobile wireless network node 420.

In some examples, UE 430 may determine whether the measurement result satisfies the measurement result threshold for a certain period of time (time period threshold). UE 430 may determine that it is inside the vehicle of mobile wireless network node 420 when both the measurement result threshold and the time period threshold are satisfied. Otherwise, UE 430 may determine that it is outside the vehicle of mobile wireless network node 420.

The above measurement result threshold (e.g., the RSRP or RSPQ absolute threshold) and the time period threshold may be configured by a BS or predefined.

In some embodiments of the present disclosure, UE 430 may determine its location status based on a variation of the measurement result (e.g., RSRP or RSRQ) on the reference signal from mobile wireless network node 420 or a cell of mobile wireless network node 420. For example, UE 430 may determine whether the variation of the measurement result within a time period satisfied a threshold. UE 430 may determine that it is inside the vehicle of mobile wireless network node 420 when the variation of the measurement result within a time period is less than or equal to the variation threshold. Otherwise, UE 430 may determine that it is outside the vehicle of mobile wireless network node 420. The variation threshold and the time period may be configured by a BS or predefined.

In some embodiments of the present disclosure, UE 430 may determine its location status based on the speed of UE 430 and mobile wireless network node 420, the moving direction(s) of UE 430 and mobile wireless network node 420, or any combination thereof. The speed and moving direction of mobile wireless network node 420 may refer to those of the vehicle on which mobile wireless network node 420 is mounted. For example, the camping or serving cell of UE 430 may inform UE 430 the speed and moving direction of mobile wireless network node 420. UE 430 may use various methods to determine whether it is inside or outside the vehicle of mobile wireless network node 420 based on the information.

In some embodiments of the present disclosure, UE 430 may determine its location status based on an indication from an application layer of UE 430. In some examples, the access stratum (AS) of UE 430 may trigger an inquiry to the application layer of UE 430, which may feed back the status of UE 430. The application layer may use various methods to determine the status of UE 430. For example, the determination of the UE status can be realized by a manual behavior, e.g., a user interaction. In some examples, the application layer of UE 430 may trigger a notification to the AS of UE 430 when the UE status has changed.

UE 430 may then transmit the determined location status to at least one of mobile wireless network node 420 and BS 410. For example, in operation 415, UE 430 may transmit the determined location status to mobile wireless network node 420. For example, UE 430 may transmit the determined location status to mobile wireless network node 420 when UE 430 performs an access to mobile wireless network node 420. For example, UE 430 may transmit the determined location status to mobile wireless network node 420 periodically. For example, UE 430 may transmit the determined location status to mobile wireless network node 420 in response to a change in the location status of UE 430. For example, when UE 430 gets aboard or gets off the vehicle, mobile wireless network node 420 or BS 410 may need to be aware of the status transfer.

In operation 415, UE 430 may transmit the determined location status to BS 410 (e.g., via mobile wireless network node 420). For example, UE 430 may transmit the determined location status to BS 410 periodically. For example, UE 430 may transmit the determined location status to BS 410 in response to a request for UE location status from BS 410. For example, UE 430 may transmit the determined location status to BS 410 in response to a change in the location status of UE 430.

It should be appreciated by persons skilled in the art that the sequence of the operations in exemplary procedure 400 may be changed and some of the operations in exemplary procedure 400 may be eliminated or modified, without departing from the spirit and scope of the disclosure.

In some embodiments of the present disclosure, there may be only one hop between a mobile wireless network node (e.g., a mobile IAB node) and a BS (e.g., an IAB donor). The following embodiments of the present disclosure provide solutions for implementing such single-hop-backhauling.

In some embodiments of the present disclosure, a mobile wireless network node may only access a BS (e.g., an IAB donor) and not access a relay node (e.g., a mobile or stationary IAB node). In these embodiments, the mobile wireless network node may need to differentiate between a BS and a relay node for access. For example, the mobile wireless network node may need to differentiate between a donor-DU and an IAB-DU.

In some embodiments, a mobile wireless network node may determine whether to access a parent node based on an indication (denoted as “indication #1”) broadcast by a cell of the parent node. In some examples, indication #1 may be included in system information block 1 (SIB1). After accessing the parent node, the mobile wireless network node may serve as a mobile relay node between the parent node and a UE.

In some examples, indication #1 may indicate whether the parent node is a BS or a relay node. For example, indication #1 may indicate whether the cell is located in an IAB-donor-DU or an IAB-DU. When indication #1 indicates that the parent node is a BS, the mobile wireless network node may access the parent node. For example, indication #1 may indicate that the cell is located in a BS (e.g., an IAB-donor-DU). When indication #1 is not provided, it may suggest that the cell is not located in a BS, and the mobile wireless network node may not access the parent node.

In some examples, indication #1 may indicate whether the cell supports a mobile wireless network node or not. In some examples, indication #1 may indicate whether the cell is considered as a candidate for cell (re) selection for a mobile wireless network node or not. For example, only the cells of a BS are mobile wireless network node-supported. In some examples, indication #1 may indicate that the cell supports a mobile wireless network. When indication #1 is not provided (e.g., not broadcasted in SIB1), it suggests that a mobile wireless network node is barred from the cell. When indication #1 indicates that the cell supports a mobile wireless network node, the mobile wireless network node may access the parent node.

In some examples, indication #1 may indicate a hop count of the cell. A mobile wireless network node may only access a cell whose hop count corresponds to that of a BS. For example, the hop count of a BS (e.g., an IAB-donor-DU) may be 0 or 1, depending on the adopted numbering rule.

In some embodiments of the present disclosure, a BS may configure a cell of the BS or a relay node whether a mobile wireless network node is barred from the cell. For example, for each cell of an IAB-donor-DU and an IAB-DU, an IAB-donor-CU may configure whether a mobile wireless network node is barred from the corresponding cell.

In some embodiments of the present disclosure, the mobile wireless network node may connect to the network (e.g., the BS) in the same way as a UE. In some embodiments, the mobile wireless network node may provide its mobile attribute (for example, whether it is a mobile or a stationary wireless network node) to the BS when, for example, accessing the BS. In some examples, the mobile attribute may be indicated in an RRC setup complete message. The mobile attribute may facilitate the operation of the BS. For example, the BS can select a core network entity (e.g., an AMF) supporting a mobile relay node.

For example, a mobile IAB node may connect to an IAB donor by performing at least one of the following: an RRC connection setup procedure with the CU of the IAB donor, an authentication with the core network, a mobile-IAB-node-related context management, an access traffic-related radio bearer configuration (e.g., signaling radio bearers (SRBs) and optionally data radio bearers (DRBs)) of the mobile IAB node at the RAN side, or an operation and maintenance (OAM) connectivity establishment by using the protocol data unit (PDU) session of the MT of the mobile IAB node. As described above, the mobile IAB node can select a parent node for access based on an over-the-air indication from the DU of the IAB donor (for example, indication #1 transmitted in SIB1 to indicate the support of a mobile IAB node). In some embodiments, the mobile IAB node may provide its mobile IAB capability (e.g., the mobile attribute) to the IAB donor in an RRC setup complete message.

In some embodiments of the present disclosure, a mobile wireless network node can access a BS (e.g., an IAB donor), a relay node (e.g., a mobile or stationary IAB node), or both. In some examples, assuming that a mobile wireless network node accesses a relay node, the mobile wireless network node may switch to a BS from the relay node to implement the above-mentioned single-hop-backhauling. In these embodiments, the mobile wireless network node may need to inform the BS of the mobile attribute of the mobile wireless network node (for example, whether it is a mobile or a stationary wireless network node) when, for example, accessing the BS.

In some embodiments of the present disclosure, the mobile attribute of a mobile wireless network node may be exchanged between a source BS and a target BS in, for example, XnAP or NGAP during a handover procedure. For example, when a mobile wireless network node performs an inter-BS handover (e.g., a mobile IAB node performs an inter-CU migration), the mobile attribute of the mobile wireless network node may need to be included in a handover request message in XnAP for Xn handover, and in a handover required message and a handover request message in NGAP for NG handover.

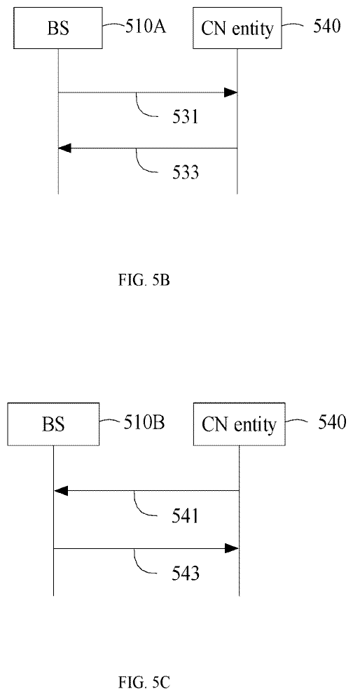

For example, referring to FIG. 5A, in operation 521, BS 510A may transmit a handover request message to BS 510B to hand over a mobile wireless network node to BS 510B. The handover request message may indicate a mobile attribute of the mobile wireless network node. In some examples, in operation 523, BS 510B may transmit a handover request acknowledge message to BS 510A as a response.

Referring to FIG. 5B, in operation 531, BS 510A may transmit a handover required message to CN entity 540 (e.g., an AMF) to hand over a mobile wireless network node to another BS. The handover required message may indicate a mobile attribute of the mobile wireless network node. In some examples, in operation 533, CN entity 540 may transmit a handover command to BS 510A as a response.

Referring to FIG. 5C, in operation 541, CN entity 540 (e.g., an AMF) may transmit a handover request message to BS 510B to hand over a mobile wireless network node from a source BS to BS 510B. The handover request message may indicate a mobile attribute of the mobile wireless network node. In some examples, in operation 543. BS 510B may transmit a handover request acknowledge message to CN entity 540 as a response.

In some embodiments of the present disclosure, the mobile attribute of a mobile wireless network node may be notified (e.g., via broadcasting) to UEs or potential descendant relay nodes (e.g., IAB nodes). In some examples, the broadcast information (e.g., SIB1 or master information block (MIB)) of a wireless network node may indicate whether the wireless network node is a mobile node or a stationary node. In some examples, when such indication is not provided in the broadcast information of a wireless network node, it may suggest that the wireless network node is a stationary node. Such indication may be used by a UE (e.g., an onboard UE or a surrounding UE) for performing cell selection or cell reselection.

In some embodiments of the present disclosure, the mobile attribute of a mobile wireless network node may be reported to a BS via RRC signaling or F1AP signaling. For example, an IAB node (e.g., the IAB-MT) may transmit its mobile attribute to an IAB donor (e.g., IAB-donor-CU) via RRC signaling. For example, an IAB node (e.g., the IAB-DU) may transmit its mobile attribute to an IAB donor (e.g., IAB-donor-CU) via F1AP signaling.

In some embodiments of the present disclosure, the mobile attribute of a mobile wireless network node may be reported to a parent wireless network node (e.g., a parent IAB node) of the mobile wireless network node.

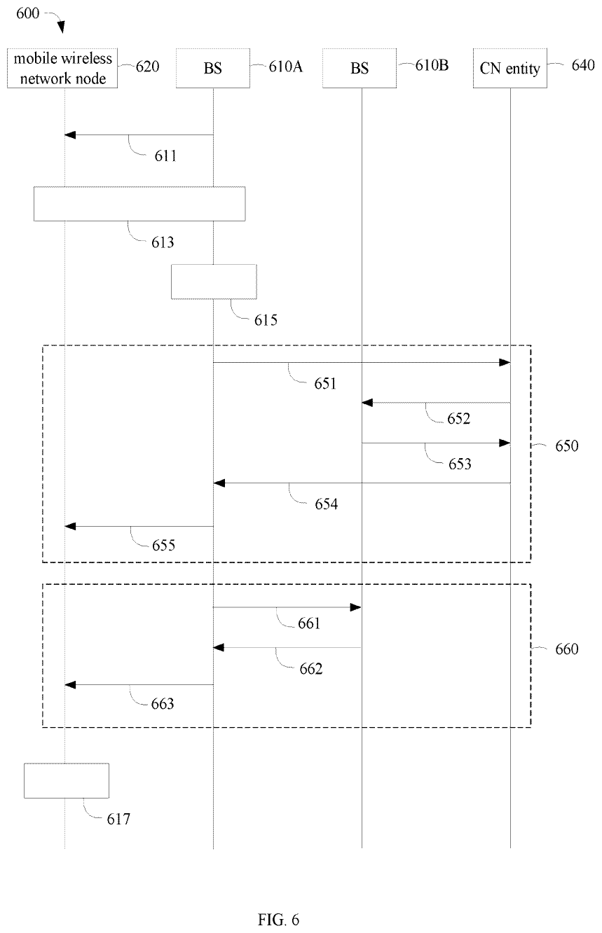

FIG. 6 illustrates a flow chart of an exemplary procedure 600 of wireless communications in accordance with some embodiments of the present disclosure. Details described in all of the foregoing embodiments of the present disclosure are applicable for the embodiments shown in FIG. 6.

Referring to FIG. 6, in operation 611, mobile wireless network node 620 may receive broadcast information from BS 610A. In some examples, the broadcast information may include indication #1 as described above. Mobile wireless network node 620 may determine whether to access BS 610A based on the broadcast information.

In operation 613, mobile wireless network node 620 may perform a random access procedure with BS 610A. Mobile wireless network node 620 may transmit an RRC setup complete message in response to a successful random access procedure. In some examples, the RRC setup complete message may indicate the mobile attribute of mobile wireless network node 620.

In operation 615, BS 610A may determine to hand over mobile wireless network node 620 to another BS. In some examples, an exemplified NG handover procedure 650 may be performed. In some examples, an exemplified Xn handover procedure 660 may be performed.

For example, as shown in procedure 650, BS 610A may transmit, in operation 651, a handover required message to CN entity 640 to hand over mobile wireless network node 620. The handover required message may indicate the mobile attribute of mobile wireless network node 620. In operation 652, CN entity 640 may transmit a handover request message to BS 610B to hand over mobile wireless network node 620 from BS 610A to BS 610B. The handover request message may indicate the mobile attribute of mobile wireless network node 620. In operation 653, BS 610B may transmit a handover request acknowledge message to CN entity 640. In operation 654, CN entity 640 may transmit a handover command to BS 610A. In operation 655, BS 610A may transmit the handover command to mobile wireless network node 620.

For example, as shown in procedure 660, BS 610A may transmit, in operation 661, a handover request message to BS 610B to hand over mobile wireless network node 620 from BS 610A to BS 610B. The handover request message may indicate the mobile attribute of mobile wireless network node 620. In operation 662, BS 610B may transmit a handover request acknowledge message to BS 610A. In operation 663, BS 610A may transmit a handover command to mobile wireless network node 620.

In operation 617, mobile wireless network node 620 may switch to the target cell of BS 610B. Mobile wireless network node 620 may transmit a handover complete message to BS 610B in response to a successful handover.

It should be appreciated by persons skilled in the art that the sequence of the operations in exemplary procedure 600 may be changed and some of the operations in exemplary procedure 600 may be eliminated or modified, without departing from the spirit and scope of the disclosure.

In some embodiments of the present disclosure, a mobile wireless network node (e.g., a mobile IAB node) may support one or more working modes, including but not limited to a private working (e.g., for a personal car) mode and a public manner (e.g., for a bus). The following embodiments of the present disclosure provide solutions for supporting one or more working modes at a mobile wireless network node.

In some embodiments, when a mobile wireless network node is in a private working mode, only some UEs (e.g., private UEs that belong to the owner of the car) may be allowed to access the mobile wireless network node. To differentiate between private UEs and other UEs (e.g., public UEs), a list of UEs that are allowed to access the mobile wireless network node may be generated by the mobile wireless network node, and may be reported to the BS for access control. For example, the list of UEs may be added manually by a user.

In some embodiments, a mobile wireless network node may report to a BS (e.g., IAB-donor-CU) at least one of the following: the one or more working modes supported by the mobile wireless network node, the current working mode of the mobile wireless network node, and the list of UEs allowed to access the mobile wireless network node. In some embodiments, a BS may configure a working mode for the mobile wireless network node.

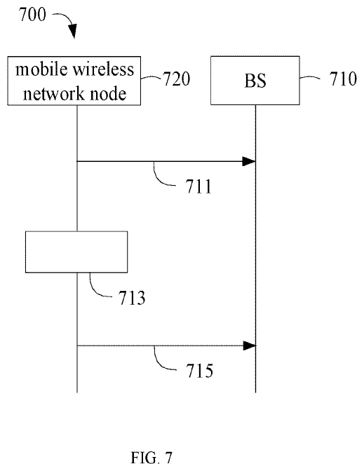

FIG. 7 illustrates a flow chart of an exemplary procedure 700 of wireless communications in accordance with some embodiments of the present disclosure. Details described in all of the foregoing embodiments of the present disclosure are applicable for the embodiments shown in FIG. 7.

Referring to FIG. 7, mobile wireless network node 720 may connect to BS 710. In some examples, mobile wireless network node 720 may be a mobile IAB node and BS 710 may be an IAB donor.

In operation 711, mobile wireless network node 720 may transmit the working modes supported by mobile wireless network node 720 to BS 710. In some examples, mobile wireless network node 720 may transmit its current working mode to BS 710. The current working mode may be selected by mobile wireless network node 720 per se, or be configured by a BS (e.g., BS 710).

In some examples, mobile wireless network node 720 may generate a list of UEs allowed to access mobile wireless network node 720 when mobile wireless network node 720 is in a private working mode. Mobile wireless network node 720 may transmit the list of UEs to BS 710. When mobile wireless network node 720 is in a private working mode, BS 710 may perform access control based on the list of UEs, for example, only allow the UE(s) in the list of UEs to perform an access to a cell of mobile wireless network node 720.

In some examples, mobile wireless network node 720 may report the list of UEs allowed to access mobile wireless network node 720 periodically. In some examples, in response to a change in the list, mobile wireless network node 720 may report the updated list or the change in the list to BS 710. For example, in operation 713, mobile wireless network node 720 may change the list of UEs allowed to access mobile wireless network node 720. Mobile wireless network node 720 may transmit the updated list or the change in the list to BS 710 in operation 715.

In some examples, mobile wireless network node 720 or BS 710 may trigger a working mode switch at mobile wireless network node 720. For example, mobile wireless network node 720 may select a working mode from the at least one supported working mode and may apply the selected working mode. For example, BS 710 may configure a working mode for mobile wireless network node 720 via F1AP or RRC signaling. Mobile wireless network node 720 may apply the configured working mode.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a flow chart of an exemplary procedure 800 for wireless communications in accordance with some embodiments of the present disclosure. Details described in all of the foregoing embodiments of the present disclosure are applicable for the embodiments shown in FIG. 8. In some examples, the procedure may be performed by a UE, for example, UE 130 in FIG. 1.

Referring to FIG. 8, in operation 811, a UE may determine a location status of the UE relative to a mobile wireless network node based on a criterion. The mobile wireless network node may be allowed to serve as a mobile relay node between a BS and the UE. In some embodiments of the present disclosure, the mobile wireless network node may be mounted on a vehicle. The location status of the UE relative to the mobile wireless network node may include inside or outside of the vehicle. The mobile wireless network node may be a mobile IAB node. The BS may be an IAB donor.

In some embodiments of the present disclosure, determining the location status of the UE based on a criterion may include determining the location status of the UE based on at least one of the following: a measurement result (e.g., RSPR or RSPQ) on a reference signal from the mobile wireless network node; a variation of the measurement result on the reference signal from the mobile wireless network node; at least one of a speed and moving direction of the UE and the mobile wireless network node; or an indication from an application layer of the UE.

In some embodiments of the present disclosure, to determine the location status of the UE based on the measurement result, the UE may determine whether the measurement result is greater than or equal to a threshold, or is greater than or equal to the threshold for a time period. In some embodiments of the present disclosure, to determine the location status of the UE based on the variation of the measurement result, the UE may determine whether the variation of the measurement result within a time period is less than or equal to a threshold.

In some embodiments of the present disclosure, determining the location status of the UE may include at least one of the following: determining the location status of the UE periodically; determining the location status of the UE in response to a request from the mobile wireless network node or the BS; determining the location status of the UE when the UE detects the mobile wireless network node or detects a cell of the mobile wireless network node; or determining the location status of the UE when the UE has accessed the mobile wireless network node.

In operation 813, the UE may transmit the determined location status of the UE to at least one of the mobile wireless network node or the BS.

In some embodiments of the present disclosure, transmitting the determined location status of the UE to at least one of the mobile wireless network node or the BS may include at least one of: transmitting the determined location status of the UE to the mobile wireless network node when the UE performs an access to the mobile wireless network node; transmitting the determined location status of the UE to the BS in response to a request for the location status of the UE from the BS; or transmitting the determined location status of the UE to at least one of the mobile wireless network node or the BS in response to a change in the location status of the UE.

It should be appreciated by persons skilled in the art that the sequence of the operations in exemplary procedure 800 may be changed and some of the operations in exemplary procedure 800 may be eliminated or modified, without departing from the spirit and scope of the disclosure.

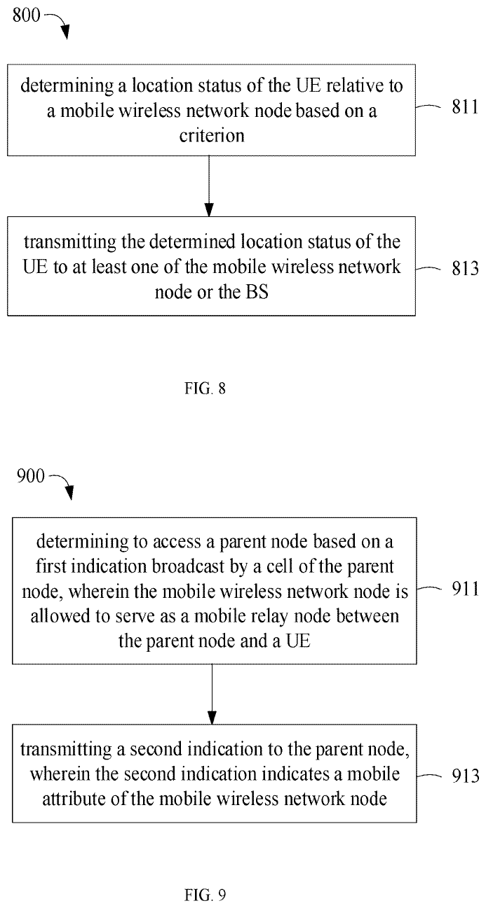

FIG. 9 illustrates a flow chart of an exemplary procedure 900 for wireless communications in accordance with some embodiments of the present disclosure. Details described in all of the foregoing embodiments of the present disclosure are applicable for the embodiments shown in FIG. 9.

Referring to FIG. 9, in operation 911, a mobile wireless network node may determine to access a parent node based on a first indication broadcast by a cell of the parent node. The mobile wireless network node may be allowed to serve as a mobile relay node between the parent node and a UE. For example, the mobile wireless network node may be an IAB node. The first indication may be included in SIB1.

In some embodiments of the present disclosure, the first indication may indicate at least one of the following: whether the parent node is a BS or a relay node; the parent node is a BS; whether the cell is located in an IAB-donor-DU or an IAB-DU; the cell is located in an IAB-donor-DU; whether the cell supports a mobile wireless network node or not; the cell supports a mobile wireless network node; whether the cell can be considered as a candidate for cell selection or cell reselection for a mobile wireless network node or not; or a hop count of the cell.

In operation 913, the mobile wireless network node may transmit a second indication to the parent node. The second indication may indicate a mobile attribute of the mobile wireless network node. The parent node may be a BS (e.g., an IAB donor) or a relay node (e.g., an IAB node).

In some embodiments of the present disclosure, the mobile wireless network node may perform at least one of the following: broadcasting an indication indicating the mobile attribute of the mobile wireless network node; or transmitting a reference signal specific for determining a location status of a UE. In some embodiments of the present disclosure, the reference signal may be transmitted only when a speed of the mobile wireless network node is greater than or equal to a threshold.

In some embodiments of the present disclosure, the mobile wireless network node may transmit at least one of the following to the parent node: at least one working mode supported by the mobile wireless network node; a current working mode of the mobile wireless network node; or a list of UEs allowed to access the mobile wireless network node. The at least one working mode may include a public working mode and a private working mode.

In some embodiments of the present disclosure, the mobile wireless network node may perform at least one of the following: receiving a working mode configuration from the parent node; periodically transmitting a list of UEs allowed to access the mobile wireless network node to the parent node; transmitting the list of UEs allowed to access the mobile wireless network node to the parent node in response to a change in the list; or transmitting the change in the list of UEs to the parent node.

In some embodiments of the present disclosure, the mobile wireless network node may perform at least one of the following: selecting a working mode from at least one working mode supported by the mobile wireless network node and applying the selected working mode; applying a working mode configured by the parent node; or generating a list of UEs allowed to access the mobile wireless network node.

It should be appreciated by persons skilled in the art that the sequence of the operations in exemplary procedure 900 may be changed and some of the operations in exemplary procedure 900 may be eliminated or modified, without departing from the spirit and scope of the disclosure.

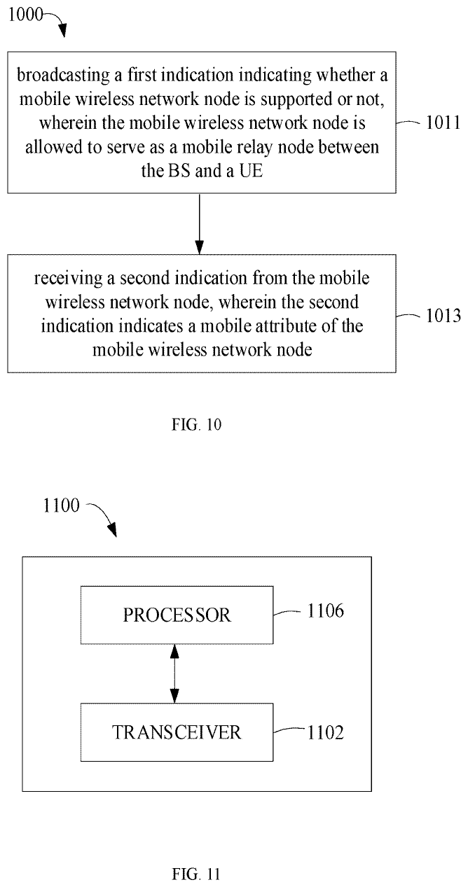

FIG. 10 illustrates a flow chart of an exemplary procedure 1000 for wireless communications in accordance with some embodiments of the present disclosure. Details described in all of the foregoing embodiments of the present disclosure are applicable for the embodiments shown in FIG. 10.

Referring to FIG. 10, in operation 1011, a BS may broadcast a first indication indicating that a mobile wireless network node is supported, wherein the mobile wireless network node may be allowed to serve as a mobile relay node between the BS and a UE.

In some embodiments of the present disclosure, broadcasting the first indication may include broadcasting at least one of the following in a cell of the BS: whether the cell is located in a BS or a relay node; the cell is located in a BS; whether the cell supports a mobile wireless network node or not; the cell supports a mobile wireless network node; or a hop count of the cell.

In operation 1013, the BS may receive a second indication from the mobile wireless network node, wherein the second indication indicates a mobile attribute of the mobile wireless network node.

In some embodiments of the present disclosure, the BS may transmit a handover request or a handover required message to handover the mobile wireless network node to another BS. The handover request and handover required message may include the mobile attribute of the mobile wireless network node.

In some embodiments of the present disclosure, the BS may receive at least one of the following from the mobile wireless network node: at least one working mode supported by the mobile wireless network node, wherein the at least one working mode comprises a public working mode and a private working mode; a current working mode of the mobile wireless network node; or a list of UEs allowed to access the mobile wireless network node.

In some embodiments of the present disclosure, the BS may perform at least one of the following: transmitting a working mode configuration to the mobile wireless network node; periodically receiving a list of UEs allowed to access the mobile wireless network node; receiving the list of UEs allowed to access the mobile wireless network node from the mobile wireless network node in response to a change in the list; or receiving the change in the list of UEs.

In some embodiments of the present disclosure, the BS may perform an access control for the mobile wireless network node based on the list of UEs when the mobile wireless network node is in a private working mode.

In some embodiments of the present disclosure, the BS may configure a cell of the BS or a relay node whether the mobile wireless network node is barred from the cell.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

FIG. 11 illustrates a block diagram of an exemplary apparatus 1100 according to some embodiments of the present disclosure.

As shown in FIG. 11, the apparatus 1100 may include at least one processor 1106 and at least one transceiver 1102 coupled to the processor 1106. The apparatus 1100 may be a UE, a mobile wireless network node (e.g., an IAB node), or a BS (e.g., an IAB donor, IAB donor-CU, or IAB donor-DU).

Although in this figure, elements such as the at least one transceiver 1102 and processor 1106 are described in the singular, the plural is contemplated unless a limitation to the singular is explicitly stated. In some embodiments of the present application, the transceiver 1102 may be divided into two devices, such as a receiving circuitry and a transmitting circuitry. In some embodiments of the present application, the apparatus 1100 may further include an input device, a memory, and/or other components.

In some embodiments of the present application, the apparatus 1100 may be a UE. The transceiver 1102 and the processor 1106 may interact with each other so as to perform the operations with respect to the UE described in FIGS. 1-10. In some embodiments of the present application, the apparatus 1100 may be a mobile wireless network node. The transceiver 1102 and the processor 1106 may interact with each other so as to perform the operations with respect to the mobile wireless network node or the IAB node (mobile or stationary) described in FIGS. 1-10. In some embodiments of the present application, the apparatus 1100 may be a BS. The transceiver 1102 and the processor 1106 may interact with each other so as to perform the operations with respect to the BS, the IAB donor, IAB donor-CU, or IAB donor-DU described in FIGS. 1-10.

In some embodiments of the present application, the apparatus 1100 may further include at least one non-transitory computer-readable medium.

For example, in some embodiments of the present disclosure, the non-transitory computer-readable medium may have stored thereon computer-executable instructions to cause the processor 1106 to implement the method with respect to the UE as described above. For example, the computer-executable instructions, when executed, cause the processor 1106 interacting with transceiver 1102 to perform the operations with respect to the UE described in FIGS. 1-10.

For example, in some embodiments of the present disclosure, the non-transitory computer-readable medium may have stored thereon computer-executable instructions to cause the processor 1106 to implement the method with respect to the mobile wireless network node or the IAB node (mobile or stationary) as described above. For example, the computer-executable instructions, when executed, cause the processor 1106 interacting with transceiver 1102 to perform the operations with respect to the mobile wireless network node or the IAB node (mobile or stationary) described in FIGS. 1-10.

In some embodiments of the present disclosure, the non-transitory computer-readable medium may have stored thereon computer-executable instructions to cause the processor 1106 to implement the method with respect to the BS, the IAB donor, IAB donor-CU, or IAB donor-DU as described above. For example, the computer-executable instructions, when executed, cause the processor 1106 interacting with transceiver 1102 to perform the operations with respect to the BS, the IAB donor, IAB donor-CU, or IAB donor-DU described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including.” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a.” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first.” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
determine a location status of the UE relative to a mobile wireless network node based on a criterion, wherein the mobile wireless network node is configured as a mobile relay node between a base station (BS) and the UE; and
transmit the location status of the UE to at least one of the mobile wireless network node or the BS.

2. The UE of claim 1, wherein the mobile wireless network node is mounted on a vehicle and the location status of the UE relative to the mobile wireless network node comprises inside or outside of the vehicle.

3. The UE of claim 1, wherein the criterion to determine the location status of the UE includes at least one of:
a measurement result on a reference signal from the mobile wireless network node;
a variation of the measurement result on the reference signal from the mobile wireless network node;
at least one of a speed or moving direction of the UE and the mobile wireless network node; or
an indication from an application layer of the UE.

4. The UE of claim 1, wherein, to determine the location status of the UE, the at least one processor is configured to cause the UE to at least one of:
determine the location status of the UE periodically;
determine the location status of the UE in response to a request from the mobile wireless network node or the BS;
determine the location status of the UE when the UE detects the mobile wireless network node or detects a cell of the mobile wireless network node; or
determine the location status of the UE when the UE has accessed the mobile wireless network node.

5. The UE of claim 1, wherein, to transmit the location status of the UE to at least one of the mobile wireless network node or the BS, the at least one processor is configured to cause the UE to transmit the location status of the UE to at least one of:
the mobile wireless network node when the UE performs an access to the mobile wireless network node;
the BS in response to a request for the location status of the UE from the BS; or
at least one of the mobile wireless network node or the BS in response to a change in the location status of the UE.

6. A mobile wireless network node, comprising:
at least one memory; and
at least one processor coupled with the at least one memory and configured to cause the mobile wireless network node to:
determine to access a parent node based on a first indication broadcast by a cell of the parent node, wherein the mobile wireless network node is allowed to serve configured as a mobile relay node between the parent node and a user equipment (UE); and
transmit a second indication to the parent node, wherein the second indication indicates a mobile attribute of the mobile wireless network node.

7. The mobile wireless network node of claim 6, wherein the first indication indicates at least one of:
whether the parent node is a base station (BS) or a relay node;
the parent node is the BS;
whether the cell supports the mobile wireless network node;
the cell supports the mobile wireless network node; or
a hop count of the cell.

8. The mobile wireless network node of claim 6, wherein the at least one processor is configured to cause the mobile wireless network node to at least one of the following:
broadcast an indication indicating the mobile attribute of the mobile wireless network node; or
transmit a reference signal specific for determining a location status of the UE.

9. The mobile wireless network node of claim 6, wherein the at least one processor is configured to cause the mobile wireless network node to transmit, to the parent node, at least one of:
at least one working mode supported by the mobile wireless network node, wherein the at least one working mode comprises a public working mode or a private working mode;
a current working mode of the mobile wireless network node; or
a list of UEs allowed to access the mobile wireless network node.

10. The mobile wireless network node of claim 6, wherein the at least one processor is configured to cause the mobile wireless network node to at least one of:
receive a working mode configuration from the parent node;
periodically transmit, to the parent node, a list of UEs allowed to access the mobile wireless network node;
transmit, to the parent node, the list of UEs allowed to access the mobile wireless network node in response to a change in the list of UEs; or
transmit, to the parent node, the change in the list of UEs.

11. A base station (BS) for wireless communication, comprising:
at least one memory; and
at least one processor coupled with the at least one memory and configured to cause the BS to:
broadcast a first indication indicating that a mobile wireless network node is supported, wherein the mobile wireless network node is configured as a mobile relay node between the BS and a user equipment (UE); and
receive a second indication from the mobile wireless network node, wherein the second indication indicates a mobile attribute of the mobile wireless network node.

12. The BS of claim 11, wherein, to broadcast the first indication, the at least one processor is configured to cause the BS to broadcast in a cell of the BS at least one of:
whether the cell is located in the BS or a relay node;
the cell is located in the BS;
whether the cell supports the mobile wireless network node;
the cell supports the mobile wireless network node; or
a hop count of the cell.

13. The BS of claim 11, wherein the at least one processor is configured to cause the BS to:
transmit at least one of a handover request or a handover required message to handover the mobile wireless network node to another BS, wherein the at least one of the handover request or the handover required message comprises the mobile attribute of the mobile wireless network node.

14. The BS of claim 11, wherein the at least one processor is configured to cause the BS to receive, from the mobile wireless network node, at least one of:
at least one working mode supported by the mobile wireless network node, wherein the at least one working mode comprises a public working mode or a private working mode;
a current working mode of the mobile wireless network node; or
a list of UEs allowed to access the mobile wireless network node.

15. The BS of claim 11, wherein the at least one processor is configured to cause the BS to at least one of the following:
transmit a working mode configuration to the mobile wireless network node;
periodically receive a list of UEs allowed to access the mobile wireless network node;
receive the list of UEs allowed to access the mobile wireless network node in response to a change in the list of UEs; or
receive the change in the list of UEs.

16. A method performed by a mobile wireless network node, the method comprising:
determining to access a parent node based on a first indication broadcast by a cell of the parent node, the mobile wireless network node configured as a mobile relay node between the parent node and a user equipment (UE); and
transmitting, to the parent node, a second indication that indicates a mobile attribute of the mobile wireless network node.

17. The method of claim 16, wherein the first indication indicates that the cell supports the mobile wireless network node.

18. The method of claim 16, wherein the first indication indicates at least one of:
whether the parent node is a base station (BS) or a relay node;
the parent node is the BS;
whether the cell supports the mobile wireless network node;
the cell supports the mobile wireless network node; or
a hop count of the cell.

19. The method of claim 16, further comprising at least one of:
broadcasting an indication indicating the mobile attribute of the mobile wireless network node; or
transmitting a reference signal specific for determining a location status of the UE.

20. The method of claim 16, further comprising transmitting, to the parent node, at least one of:
at least one working mode supported by the mobile wireless network node,
the at least one working mode comprising a public working mode or a private working mode;
a current working mode of the mobile wireless network node; or
a list of UEs allowed to access the mobile wireless network node.
